(19) United States
(12) Patent Application Publication
(10) Pub. No.: US 2024/0217147 A1
(43) Pub. Date: Jul. 4, 2024

(54) METHODS FOR BRANDING POLYLACTIC ACID-BASED FOAM ARTICLES

(71) Applicant: Lifoam Industries, LLC, Greer, SC (US)

(72) Inventors: Saumitra Bhargava, Clarksville, MD (US); Jonathan Godfrey, Joppa, MD (US)

(21) Appl. No.: 18/303,162

(22) Filed: Oct. 2, 2023

Related U.S. Application Data
(60) Provisional application No. 63/477,935, filed on Dec. 30, 2022.

(51) Int. Cl. B29C 44/56; B29C 44/34; C08J 9/00; C08J 9/36; C08K 3/04

(52) U.S. Cl. CPC B29C 44/5636; B29C 44/3415; C08J 9/0066; C08J 9/36; C08K 3/04; B29K 2105/0032; C08J 2367/04

(57) ABSTRACT

Methods for branding foam articles are provided. The methods include forming molded foam articles from polylactic acid, heating a surface, and pressing the surface against the molded foam article to produce a brand. Branding PLA-based molded foam articles advantageously produces a brand having high contrast and high resolution compared to other foam material.

### CROSS-REFERENCE TO RELATED APPLICATION

This application claims priority to U.S. Provisional Patent Application No. 63/477,935, filed Dec. 30, 2022, which is incorporated herein by reference.

### FIELD OF THE DISCLOSURE

This disclosure relates generally to molded foam articles and, in particular, relates to the branding molded foam articles formed from polylactic acid.

### BACKGROUND

Molded bead foam polyester articles are being commercialized as expandable polystyrene (EPS) replacement in thermal insulation and/or impact protection applications. EPS is a widely used bead foam material having a well-established manufacturing process that is easily reproducible. EPS molding is the oldest and fastest bead molding process commercially practiced. Other bead foams have gained popularity in recent years, particularly recyclable and biodegradable bead foams formed out of, for example, polylactic acid (PLA).

These molded bead foam polyester articles are commonly used for shipping furniture, televisions, meal kits, confectionary products, cakes, other perishable goods, and medical items such as vaccines. Manufacturers of goods who rely on molded bead foam polyester articles typically display their brand or product identification information by marking or labeling a corrugated cardboard box that contains the molded bead foam polyester article and the goods themselves. However, attempts to eliminate reliance on corrugated cardboard boxes require a means of marking molded bead foam polyester itself as the sole container of goods.

Previous attempts to use molded bead foam polyesters as product packaging have used screen printing or direct printing for product identification. However, even printing on EPS is challenging as specially formulated inks and solvents are necessary to form a robust marking with suitable contrast and robustness. Furthermore, each of these methods are easily forged. A more secure means of product identification on molded bead foam polyester product packaging is incorporating the product identification into the foam beads themselves.

One method for incorporating product identification into the molded bead foam polyester product packaging is to include the product identification features in the molding tooling itself so that the molded bead foam polyester is imparted with the product identification. However, these features are often prone to flaking, and the resulting features have the same color as the surrounding molded bead foam, significantly impairing the legibility of the product identification. Furthermore, the cost for having multiple product identification markings is extraordinarily more expensive because every mold requires custom tooling and can only be used for a single product.

Another method for incorporating product identification into the molded bead foam polyester product packaging is “branding,” where product identification is embossed into the surface of the molded bead foam polyester. Branding EPS thermal shippers and protective packaging, however, results in the branded lettering or logo having the same color as the unbranded EPS; this poor contrast makes the lettering or logo challenging to read. When branding EPS, the legibility of the branded lettering depends on the size of the foam beads used to produce the molded EPS, with smaller beads having improved legibility. However, smaller EPS beads are much more challenging to mold into useable article dimensions. Furthermore, branded thermal shippers are more expensive because of the need to carry inventory of thermal shippers for each marking, lettering, or good. Further still, the heat and pressure necessary to produce a usable brand, notwithstanding poor legibility or poor contrast, typically results in branded bead foam with poorer adhesion that easily separates from the unbranded bead foam.

Accordingly, improved branding techniques and materials are needed for overcoming one or more of the technical challenges described above.

### BRIEF DESCRIPTION OF THE DRAWINGS

FIG. 1A is a molded foam article branded at 350° F. in accordance with the present disclosure.

FIG. 1B is a molded foam article branded at 400° F. in accordance with the present disclosure.

FIG. 2A is a molded foam article having additives branded at 400° F. in accordance with the present disclosure.

FIG. 2B is a molded foam article having additives branded at 350° F. in accordance with the present disclosure.

FIG. 3A is a number of molded foam articles branded for varying times in accordance with the present disclosure.

FIG. 3B is a molded foam article branded for 2 seconds in accordance with the present disclosure.

FIG. 4 is a branded EPS-based molded foam article.

FIG. 5A is a brand for branding molded foam articles.

FIG. 5B is a molded foam article branded by the brand in FIG. 5A in accordance with the present disclosure.

### DETAILED DESCRIPTION

Methods for branding foam articles are provided herein including methods of branding foam articles formed from polylactic acid (PLA), also referred to herein as expandable polylactic acid (ePLA). In particular, it has been unexpectedly discovered that forming the molded foam article from PLA advantageously enables branding with high contrast, high resolution independent of foam bead size, abrasion resistance, and the ability to brand during or after molded foam article production.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” with reference to dimensions refers to the dimension plus or minus 10%.

### Methods for Producing Branded Foam Articles

Methods for producing branded molded articles are disclosed herein. In some embodiments, the methods include producing a molded foam article from PLA. In some embodiments, producing the molded foam article may be performed according to the methods described in U.S. Pat. No. 10,518,444 to Lifoam Industries LLC, U.S. Pat. No. 10,688,698 to Lifoam Industries LLC, or U.S. Pat. No. 11,213,980 to Lifoam Industries LLC, each of which are incorporated herein by reference in their entirety. In some embodiments, producing the molded bead foam article may include a molding process and the molding process may include steps such as loading a mold with PLA-based foam beads, subjecting the mold to vacuum and/or steam to expand the foam beads into a shape defined by the shape of the mold, and ejecting the molded article from the mold.

In some embodiments, the method for producing the branded foam article includes heating a surface. In some embodiments, the surface is formed from metal, glass, ceramic, or another material having a high heat capacity. In some embodiments, the surface is a metal plate. In the exemplary embodiments described herein, the decision to recite a “metal plate” to the exclusion of other materials having high heat capacities is in the interest of brevity only. The “metal plate” may be readily substituted for, for example, a ceramic plate. The “metal plate” may, in fact, be in the form of a rod, a stamp, or another suitable shape. Any suitable surface formed form any suitable material having any suitable shape may be implemented in the methods described herein.

In some embodiments, branding the molded foam article may be performed immediately after producing the molded foam article, such as immediately after ejecting the molded foam article from the mold used to produce the molded foam article. In other embodiments, branding the molded foam article may be performed at any period of time after molding the molded foam article and after the molded foam article has cooled from the molding process. The branding step may be performed as part of a manufacturing process to, for example, impart identifying product information on the molded foam article. The branding step may be performed by an end-user, for example, as part of repurposing the molded foam article from a first use to a new, recycled use.

In some embodiments, the molded foam article has a plurality of faces. For example, a molded foam article in the form of a box may have six external faces and six internal faces. The faces may be substantially smooth, such as the faces that form a cubic box. The faces may have curved surfaces and/or edges, such as a rounded cube. Any shaped face is capable of branding as described herein. Therefore, in some embodiments, any face of the molded foam article may be branded. Conventional branding techniques do not have the ability to brand the sides of a molded foam article because the branding occurs simultaneous to molding; the mold must have smooth sidewalls to enable ejection of the molded article. It has been unexpectedly discovered that forming a molded foam article from PLA as described herein enables branding any surface of the molded foam article.

The metal plate may be heated by direct flame, convective heating, conductive heating, or radiative heating. The metal plate may be heated by, for example, dipping the metal plate in a hot fluid, fluidized bed, or substrate. The metal plate may be heated by placing the metal plate on a heated surface such as a hot plate. The metal plate may be heated using a heat gun. Any suitable means for heating the metal plate may be used depending on the application and the available heating means.

In some embodiments, the metal plate is heated to a temperature of from about 300° F. to about 800, such as about 350° F.

In some embodiments, the method includes pressing the metal plate against the molded foam article for a period of time to produce a brand. Advantageously, the use of a metal plate eliminates the need to incorporate product identification into the mold itself. The metal plate may be incorporated within the mold using a bracket or brace that enables easy removal, replacement, or updating of the metal plate. The metal plate may be heated and pressed against the molded foam article using an apparatus proximal to the molding apparatus. The metal plate may be heated and pressed against the molded foam article using an apparatus remote from the molding apparatus. The metal plate may be heated and pressed against the molded foam article immediately after molding the molded foam article, or the molded foam article may be cooled and/or stored indefinitely prior to the branding step.

In some embodiments, the metal plate includes an embossed design, characterized by the design itself being present in the metal plate in the raised portion of the embossing so that the design itself is branded into the molded foam article. In some embodiments, the metal plate includes a debossed design, characterized by the area surrounding the design, i.e., the “background,” being present in the metal plate in the raised portion so that the “background” is branded into the molded foam article. The embossed design may include text, images, figures, barcodes, QR codes, braille, or another marking suitable for identifying the product within the molded foam article, identifying the manufacturer of the product, or identifying another entity or article. In has been unexpectedly discovered that forming the molded foam article from polylactic acid enables the formation of a branded design with a resolution unobtainable on molded foam articles formed from EPS. Without being bound by any particular theory, PLA-based foam beads readily fill gaps between beads after a heating and cooling cycle. Thus, it is believed that using PLA-based foam beads create a smooth and uniform surface having higher compression and flexural moduli enabling high resolution branding. EPS, on the other hand, tends to grow brittle with foam beads that separate from one another after molding. Furthermore, PLA-based foam beads loaded with a colorant enables finer control over the color of a brand, enabling even greater contrast between the brand and the surrounding unbranded PLA. Further still, it has been unexpectedly discovered that the definition of the embossing may be finer than a single bead, i.e., a PLA-based foam bead having a bead size of around 4 to around 6 mm in size may be used to form the molded foam article, but the surface used for branding may have an embossed design with features only around 1 mm in size.

In some embodiments, the metal plate is produced using computer numerical control (CNC) machining. In some embodiments, the metal plate is produced using a lathe. In some embodiments, the metal plate is produced using a casting process. In some embodiments, the metal plate is produced by punching a metal sheet. In some embodiments, the metal plate is a modifiable metal stamp with swappable modules for different letters, numbers, codes, etc. Any suitable metal forming technique may be utilized to produce the metal plate, the brand on the metal plate, or both depending on the needs of the application and available equipment. In some embodiments, the metal plate is subsequently coated prior to heating and pressing against the molded foam article.

In some embodiments, the metal plate is pressed against the molded foam article for from about 0.5 seconds to about 8 seconds. In some embodiments, the metal plate is pressed against the molded foam article with a pressure of about 10 psi. By tuning the temperature of the metal plate, the pressure of the metal plate against the molded foam article, and the branding time, the contrast of the resulting brand may be controlled. Without intending to be bound by any particular theory, the length of time the metal plate is pressed against the molded foam article is inversely dependent on the temperature of the metal plate. For example, a metal plate at around 800° F. may be pressed against the molded foam article for as little as 0.5 seconds and produce a suitable brand.

In some embodiments, the molded foam article has a white color. In some embodiments, the brand produced by the method has a contrast ratio of greater than 2 relative to a base foam color without the use of colorants. In other embodiments, the molded foam article has a color other than white, such as gray or khaki through the addition of suitable colorants. It has been unexpectedly discovered that branding a molded foam article having a color other than white can produce a superior contrast.

In some embodiments, the method includes producing a plurality of molded foam articles and branding each of the molded foam articles. In some embodiments, the surface includes multiple embossed designs and is configured to be pressed against each molded article in the plurality of molded foam articles so as to brand each article simultaneously. In other embodiments, the brand may be heated to a first temperature before being pressed against a first molded foam article to produce a brand, then pressed against a second molded foam article to produce a brand, and so on. Molded foam articles in numbers ranging from 10 articles to 10,000,000 molded foam articles may be swiftly branded with any desired brand. Previous branding techniques relied on producing a brand during the molding process, which substantially limits the number of branded articles that may be produced.

### Examples

### Example 1: Producing Branding with No Color Change Using ePLA Molded Article

A molded foam article was produced as described herein using expandable polylactic acid (ePLA) and branded according to Table 1.

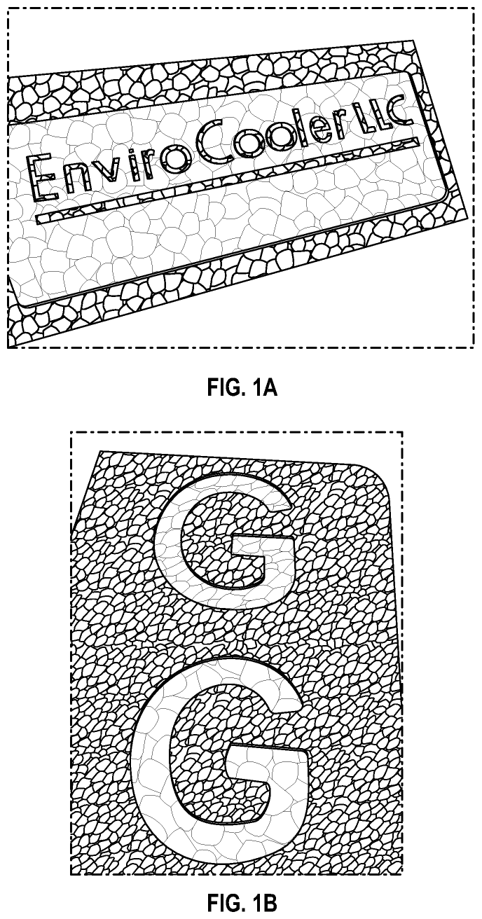

TABLE 1
Branding ePLA molded article

| Sample ID | Brand temperature | Branding Time | FIG. |
|---|---|---|---|
| 1.1 | 350° F. | ~2.5 seconds | FIG. 1A |
| 1.2 | 400° F. | ~2.5 seconds | FIG. 1B |

An aluminum plate bearing a logo was heated to 350° F. and pressed against the molded foam article using 10 psi of force for 2-3 seconds. The results are depicted in FIG. 1A.

An iron plate bearing the letter “G” was heated to 400° F. and pressed against the molded foam article using 10 psi of force for 2-3 seconds. The results are depicted in FIG. 1B. As shown in FIGS. 1A and 1B, a short exposure time with a metal plate heated to between about 350° F. and 400° F. produces a clean brand that is easily reproducible, but the contrast is relatively poor because the foam article experiences no color change.

### Example 2: Producing Higher Contrast Branding Using ePLA Molded Foam with Graphite Additives

A molded foam article was produced as described in U.S. Provisional Pat. App. No. 63/363,213 to Lifoam Industries, LLC, which is incorporated herein by reference in its entirety, using expandable polylactic acid (ePLA) having graphite additives and branded according to Table 2.

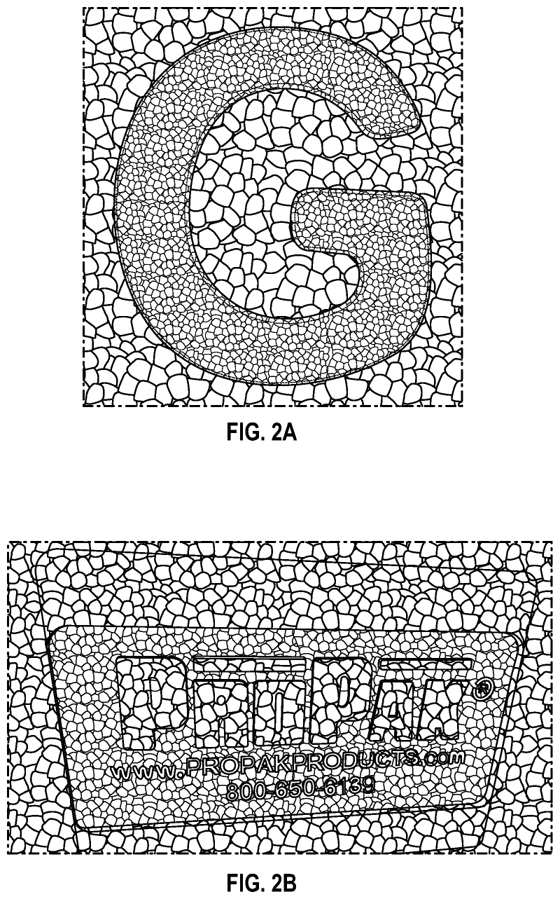

TABLE 2
Branding ePLA molded article with additives

| Sample ID | Brand temperature | Branding Time | FIG. |
|---|---|---|---|
| 2.1 | 400° F. | ~2.5 seconds | FIG. 2A |
| 2.2 | 350° F. | ~2.5 seconds | FIG. 2B |

The iron plate bearing the letter “G” used in Example 1 was heated to 400° F. with a heat gun and pressed against the molded foam article using 10 psi of force for 2-3 seconds. The results are depicted in FIG. 2A.

An aluminum plate bearing a logo was heated to 350° F. using a hot plate and pressed against the molded foam article using 10 psi force for 2-3 seconds. The results are depicted in FIG. 2B. As shown in FIGS. 2A and 2B, the inclusion of additives in the ePLA-based molded foam article improves the contrast of the branded logo.

### Example 3: Comparison of Branding Times

Molded foam articles were produced as described herein. An aluminum mold plate bearing a logo was heated to 350° F. and pressed against the molded foam article for varying lengths of time as described in Table 3.

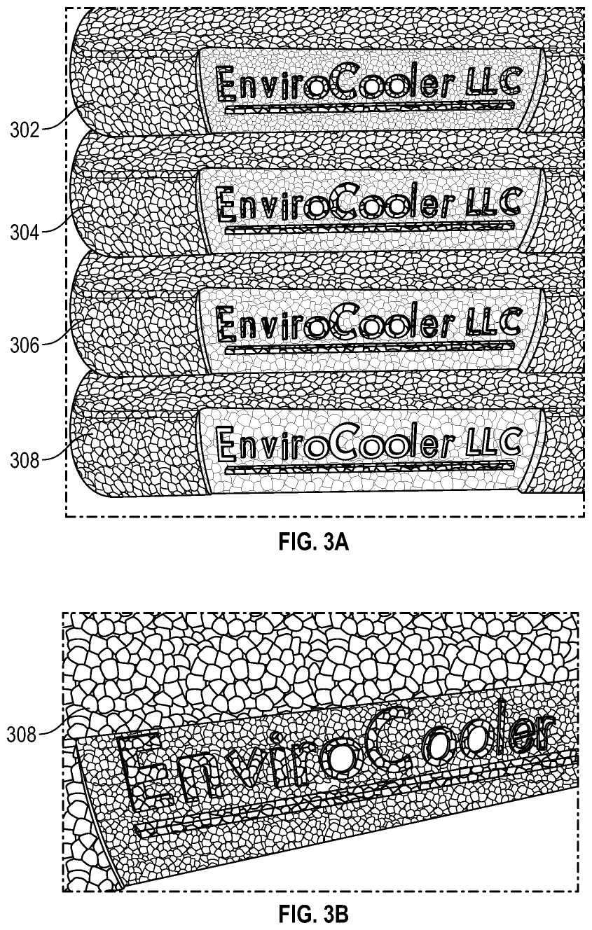

TABLE 3
Comparison of branding times

| Sample ID | Brand temperature | Branding Time | FIG. |
|---|---|---|---|
| 302 | 350° F. | 8 seconds | FIG. 3A |
| 304 | 350° F. | 6 seconds | |
| 306 | 350° F. | 4 seconds | |
| 308 | 350° F. | 2 seconds | FIGS. 3A & 3B |

The results are depicted in FIG. 3A with a detailed look at sample 2.3.4 depicted in FIG. 3B. As shown in FIGS. 3A and 3B, longer branding times correspond to a darker “brand” imparted to the foam article. Depending on the depth of the embossed design on the metal plate, the raised portions of the foam article may experience a darkening effect and inhibit improved contrast. This can be mitigated with deeper channels in the embossed metal plate.

### Example 4: Branding Expandable Polystyrene (EPS)

An EPS molded article was produced according to conventional EPS molding methods and branded as described in Table 4.

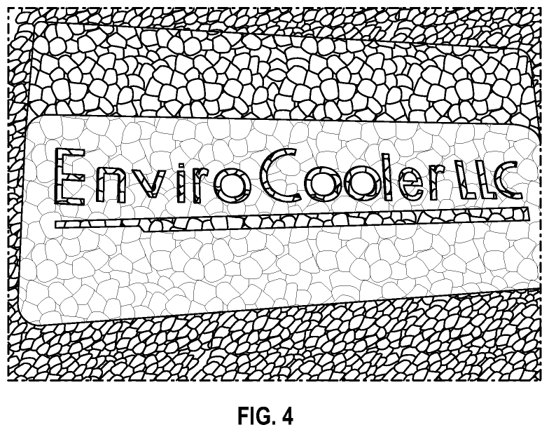

TABLE 4
Branding EPS-based molded article

| Sample ID | Brand temperature | Branding Time | FIG. |
|---|---|---|---|
| EPS | 350° F. | ~2.5 seconds | FIG. 4 |

### Example 5: Contrast Analysis Using Modified WCAG 2.0 Guidelines

The World Wide Web Consortium's (W3C) Web Accessibility Initiative (WAI) published Web Content Accessibility Guidelines, often shortened to WCAG 2.0, in 2008. This technical standard is referenced for websites to comply with accessibility on the internet and is required for U.S. federal websites as well as all websites in Ontario, Canada. This technical standard was used as a gauge of the accessibility offered by the contrast in the branded foam articles described in Examples 1-4 since no such accessibility standard exists for packaging. The technical standard analyzes the level of contrast between foreground colors (usually fonts on webpages) and the background color and uses that ratio to set a level classified as: fail, A, AA, and AAA. Websites where WCAG 2.0 must be complied with require a level of AA (a contrast ratio greater than 4.5) or AAA.

A color spectrum analyzer tool was used to assign a hex color code to the background and foreground of brands produced in Examples 1-4. These color codes were then submitted to a color contrast tester which outputs a contrast ratio. The ratios were then given their appropriate levels according to WCAG 2.0. The results are presented in Table 5.

TABLE 5
Modified WCAG 2.0 Test Results

| Sample | 1.1 | 2.2 | 2.3.1 | 2.3.2 | 2.3.3 | 2.3.4 | EPS |
|---|---|---|---|---|---|---|---|
| Foreground Color | #B5AFA0 | #4E4B44 | #4A4843 | #413E3A | #22201D | #171613 | #B2B1B0 |
| Background Color | #D2CEC6 | #C5C2BB | #C8C3BE | #C8C3BE | #C8C3BE | #C8C3BE | #C5C2C4 |
| Contrast Ratio | 1.39 | 4.89 | 5.62 | 6.8 | 9.29 | 10.34 | 1.21 |
| Level | Fail | AA | AA | AA | AAA | AAA | Fail |
| Branding Time | 2 sec | 2 sec | 2 sec | 4 sec | 6 sec | 8 sec | N/A |

As shown in Table 5, a higher contrast is achieved with ePLA-based foam articles using the method described herein. Even as little as 2 seconds of branding time is sufficient to yield a significant contrast. The EPS sample tested as a control produced a “Fail” result according to the test.

### Example 6: Producing Branding with Color ePLA

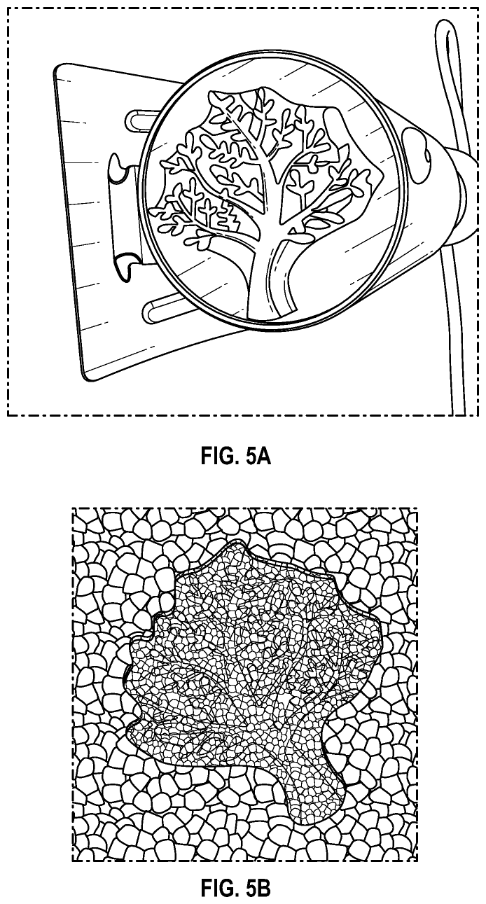

An electric brander was heated to 800° F. and pressed against a molded foam article produced as described herein using polylactic acid. The original electric brander design is depicted in FIG. 5A. The resulting brand is depicted in FIG. 5B.

At 800° F., the foam in the molded foam article melts too quickly even with extremely brief branding time (˜0.5 seconds). Without intending to be bound by any particular theory, it is possible that a larger brand may have success with the 800° F. electric brander.

### Example 7: Branding 50% EPS and 50% PE Blend

A molded foam article formed from 50% EPS and 50% polyethylene was formed according to conventional methods. However, attempts to brand this material produced no meaningful results. Increased temperatures or branding times resulted in blistering the article.

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirt and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure it not to be seen as limited by the foregoing described, but is only limited by the scope of the appended claims.

That which is claimed is:

1. A method for producing a branded foam article, the method comprising:
producing a molded foam article from polylactic acid;
heating a surface; and
pressing the surface against the molded foam article for a period of time to produce a brand.

2. The method of claim 1, wherein producing the molded foam article comprises a molding process.

3. The method of claim 1, wherein the brand has a contrast ratio of greater than 2 relative to a base foam color without the use of colorants.

4. The method of claim 1, wherein the molded foam article further comprises graphite additives or other colorants.

5. The method of claim 1, wherein the surface is formed using metal, glass, ceramic, or another material having a high heat capacity.

6. The method of claim 1, wherein the surface is a metal plate.

7. The method of claim 6, wherein the metal plate comprises an embossed design.

8. The method of claim 7, wherein the embossed design comprises text, images, barcodes, QR codes, braille, or the like.

9. The method of claim 6, wherein the metal plate comprises a debossed design.

10. The method of claim 1, wherein the period of time is from about 0.5 seconds to about 8 seconds.

11. The method of claim 1, wherein the brand has high contrast.

12. The method of claim 1, wherein the surface is heated to a temperature of from about 300° F. to about 800° F.

13. The method of claim 1, wherein the surface is heated to a temperature of about 350° F.

14. The method of claim 1, wherein the molded foam article has a white color.

15. The method of claim 1, wherein the molded foam article has a color other than white.

16. The method of claim 1, wherein heating the surface comprises convective heating, conductive heating, heating by dipping in a hot substrate, heating by placement on a hot plate, heating by applying a heat gun, or a combination thereof.

17. The method of claim 1, wherein branding the molded foam article may be performed immediately after producing the molded foam article.

18. The method of claim 1, wherein branding the molded foam article may be performed after the molded foam article has cooled.

19. The method of claim 1, wherein the molded foam article comprises one or more faces, and wherein any face may be branded.

20. The method of claim 1, wherein the surface is coated.

21. The method of claim 5, wherein the metal plate is produced using at least one of a CNC machine, a lathe, 3-D printing, compressing metal powder, or punching a metal sheet.

22. The method of claim 1, wherein the surface is pressed against the molded foam article with a pressure of about 10 psi.
